(19) United States
(12) Patent Application Publication
(10) Pub. No.: US 2025/0105663 A1
(43) Pub. Date: Mar. 27, 2025

(54) ELECTRICAL OUTLET MANAGEMENT

(71) Applicant: The ADT Security Corporation, Boca Raton, FL (US)

(72) Inventor: Karl William WIANT, II, Pelzer, SC (US)

(21) Appl. No.: 18/473,816

(22) Filed: Sep. 25, 2023

(51) Int. Cl. H02J 13/00; H02J 3/00

(52) U.S. Cl. CPC H02J 13/00002; H02J 3/003

(57) ABSTRACT

A system and method are provided. An example system includes a controller in communication with a plurality of outlets. The controller receives, from each of the plurality of outlets, data associated with power consumption of a respective outlet, updates historical data for each of the plurality of outlets based on the data received from each of the plurality of outlets, and determines a power scheme for the plurality of outlets based at least on the historical data, where the power scheme is configured such that a predicted collective power consumption of the plurality of outlets is less than a maximum output of a power source. The controller further configures, based on the power scheme, at least one of the plurality of outlets to enter the open state and at least one other of the plurality of outlets to enter the closed state.

### TECHNICAL FIELD

The present technology is generally related to electrical outlet management.

### BACKGROUND

Solar power and on-site generators (e.g., backup generators) are incorporated into many electrical systems. These and similar power sources can provide electrical power to electrical loads when typical grid power is unavailable due to one reason or another, such as grid interruption due to a storm. In addition, many electrical systems may rely on such power sources as a primary power source.

### BRIEF DESCRIPTION OF THE DRAWINGS

A more complete understanding of the present disclosure, and the attendant advantages and features thereof, will be more readily understood by reference to the following detailed description when considered in conjunction with the accompanying drawings wherein:

FIG. 1 is a diagram of an example system according to some embodiments of the present disclosure;

FIG. 2 is a block diagram of an example of a controller and outlet in the system of FIG. 1 according to some embodiments of the present disclosure;

FIG. 3 is a flowchart of an example process performed in the system of FIG. 1 according to some embodiments of the present disclosure;

FIG. 4 is a block diagram of an example of an outlet in the system of FIG. 1 according to some embodiments of the present disclosure;

FIG. 5 is a diagram of an example system according to some embodiments of the present disclosure; and

FIG. 6 is a diagram of a portion of an example system according to some embodiments of the present disclosure.

### DETAILED DESCRIPTION

As used herein, relational terms, such as “first” and “second,” “top” and “bottom,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. The terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

In embodiments described herein, the joining term, “in communication with” and the like, may be used to indicate electrical or data communication, which may be accomplished by physical contact, induction, electromagnetic radiation, radio signaling, infrared signaling or optical signaling, for example. Multiple components may interoperate and modifications and variations are possible to achieve the electrical and data communication.

In some embodiments described herein, the term “coupled,” “connected,” and the like, may be used herein to indicate a connection, although not necessarily directly, and may include wired and/or wireless connections.

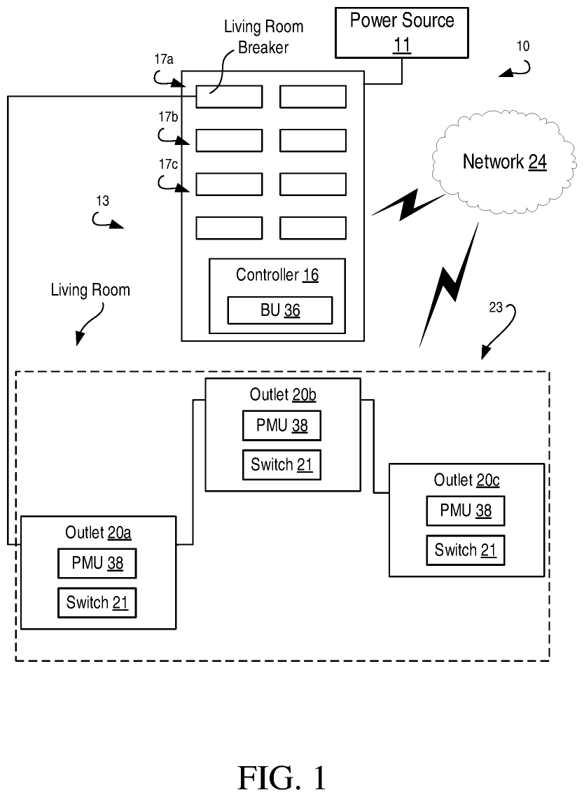

Referring to the drawing figures, in which like elements are referred to by like reference numerals, there is shown in FIG. 1 a diagram of an example system 10 according to various embodiments of the present disclosure. The system 10 may include a controller 16. The controller 16 may be in communication with one or more circuit breakers 17a-17c (collectively referred to as circuit breakers 17), which may be in communication with a power source 11. The power source 11 may provide electrical power to the system 10, and can include, for example, electrical grid power, solar power, battery power, generator power, etc. The controller 16 may be configured for controlling and/or managing aspects of the system 10. For example, controller 16 may comprise balance unit 36, which may be configured to perform various functionalities associated with the system 10, including those described herein. Further, controller 16 can be in simultaneous communication and/or configured to separately communicate with one or more outlet 20a-20c (collectively referred to as outlets 20) and/or a network 24. By way of the network 24, controller 16 may be in communication with a user, such as via a display device, user device (such as a mobile device and/or tablet), and/or a premises automation system.

One or more outlets 20 may be in electrical communication with each other to form a circuit 23. Each outlet 20 is configured to receive one or more conductors (e.g., a mating plug) of one or more electrical devices to thereby provide power to one or more electrical devices. The outlet 20 includes a power monitoring unit 38 configured to monitor power and/or associated parameters (e.g., current) use and provide such data to the controller 16. The outlet 20 also includes a switch 21 that can be operated to electrically connect or disconnect power from electrical equipment that is plugged into outlet 20. For example, outlet 20 being configured to an open state or to enter an open state may correspond to electrically disconnecting the power receptacle(s) of the outlet 20 from circuit 23. The remaining outlets 20 may be unaffected by the open state of another outlet 20. Further, outlet 20 being configured to a closed state or to enter a closed state may correspond to electrically connected the power receptacle(s) of the outlet to circuit 23 such as to be able to provide power via the power receptacle(s) of the outlet 20. Though only one circuit 23 is depicted in FIG. 1, the system 10 may include more than one circuit 23, each including one or more outlets 20.

As noted above, system 10 may include network 24 (which may refer to one or more networks 24), which may be configured to provide direct and/or indirect communication, e.g., wired and/or wireless communication, between any two or more components of system 10, e.g., controller 16 and outlet 20. In a non-limiting example, controller 16 may communicate with the outlet 20 via network 24, e.g., to communicate regarding the power usage (e.g., current usage) of the outlet 20 and perform actions related thereto. Although network 24 is shown as an intermediate network between components/devices of system 10, any component or device may communicate directly with any other component/device of system 10.

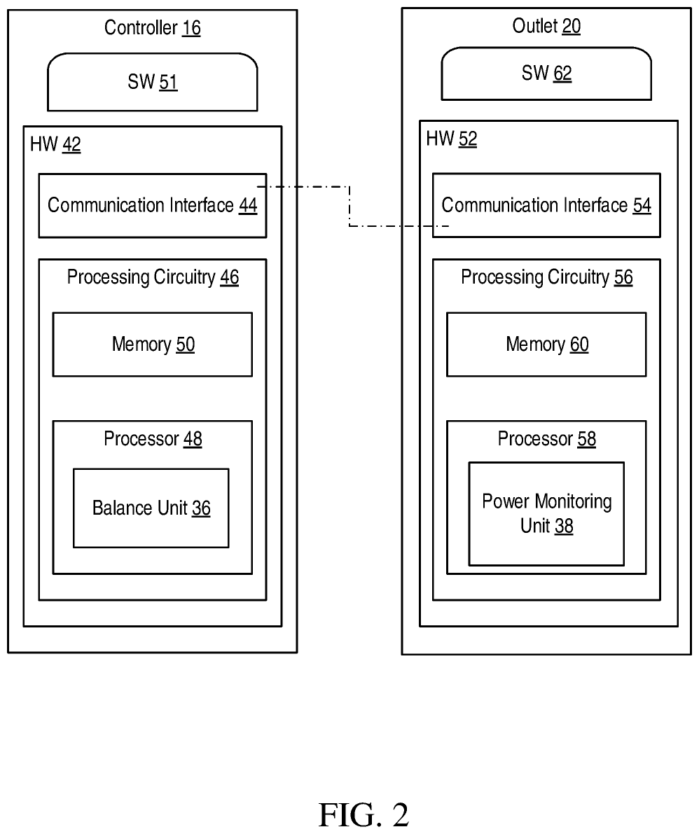

Example implementations, in accordance with embodiments of system 10 discussed in the preceding paragraphs will now be described with reference to FIG. 2. The controller 16 includes hardware 42. The hardware 42 may include processing circuitry 46. The processing circuitry 46 may include a processor 48 and a memory 50. In addition to or instead of a processor 48, the processing circuitry 46 may comprise integrated circuitry for processing and/or control, e.g., one or more processors and/or processor cores, field programmable gate arrays (FPGAs), and/or application specific integrated circuits (ASICs) adapted to execute instructions. The processor 48 may be configured to access (e.g., write to and/or read from) the memory 50, which may comprise any kind of volatile and/or nonvolatile memory, e.g., cache, buffer memory, random access memory (RAM), read-only memory (ROM), optical memory, and/or erasable programmable read-only memory (EPROM). Further, memory 50 may be configured as a storage device. The processing circuitry 46 may be configured to perform various functionality described herein. For example, computer instructions may be stored in memory 50 and/or another computer-readable medium that, when executed by the processor 48, cause the processor 48 to perform various functionality.

Hardware 42 of controller 16 may include communication interface 44 enabling controller 16 to communicate with any component or device of system 10. For example, communication interface 44 may be configured for establishing and maintaining at least a wireless or wired connection with any component or device of system 10, such as outlet 20, etc. The communication interface 44 may be formed as or may include, for example, one or more radio frequency (RF) transmitters, one or more RF receivers, and/or one or more RF transceivers.

Controller 16 further has software 51 stored internally in, for example, memory 50, or stored in external memory (e.g., database, storage array, network storage device, etc.) accessible by the controller 16 via an external connection. Software 51 may include any software or program configured to perform the steps or processes of the present disclosure, e.g., providing an interface for a user to provide an input to the controller 16 and/or receive an output from the controller 16. Further, software 51 may run and/or be included directly as part of controller 16. Software 51 may execute on a virtual machine and/or execute outside controller 16 and/or any of the components thereof.

The processing circuitry 46 may be configured to control any of methods and/or processes described herein and/or to cause such methods, and/or processes to be performed, e.g., by controller 16. Processor 48 corresponds to one or more processors 48 for performing controller 16 functions described herein. The memory 50 is configured to store data and/or files such as system data and/or other information/data described herein. In some embodiments, the software 51 may include instructions that, when executed by the processor 48 and/or processing circuitry 46, causes the processor 48 and/or processing circuitry 46 to perform the processes described herein with respect to controller 16. For example, processing circuitry 46 of the controller 16 may include balance unit 36, which may be configured to perform any of the processes, steps, or functions described herein.

The outlet 20 includes hardware 52. The hardware 52 may include processing circuitry 56. The processing circuitry 56 may include a processor 58 and a memory 60. In addition to or instead of a processor 58, the processing circuitry 56 may comprise integrated circuitry for processing and/or control, e.g., one or more processors and/or processor cores, FPGAs, and/or ASICs adapted to execute instructions. The processor 58 may be configured to access (e.g., write to and/or read from) the memory 60, which may comprise any kind of volatile and/or nonvolatile memory, e.g., cache, buffer memory, RAM, ROM, optical memory, and/or EPROM. Further, memory 60 may be configured as a storage device. The processing circuitry 56 may be configured to perform various functionality described herein. For example, computer instructions may be stored in memory 60 and/or another computer-readable medium that, when executed by the processor 58, cause the processor 58 to perform various functionality.

Hardware 52 of outlet 20 may include communication interface 54 enabling outlet 20 to communicate with any component or device of system 10. For example, communication interface 54 may be configured for establishing and maintaining at least a wireless or wired connection with any component or device of system 10, such as controller 16, etc. The communication interface 54 may be formed as or may include, for example, one or more RF transmitters, one or more RF receivers, and/or one or more RF transceivers. In one or more embodiments, the RF transceiver can communicate with the controller 16 such as to, for example, transmit information regarding the current measured by the current meter. The RF transceiver can also receive from the controller 16 commands to open or close the switch 21.

Outlet 20 further has software 62 stored internally in, for example, memory 60, or stored in external memory (e.g., database, storage array, network storage device, etc.) accessible by the outlet 20 via an external connection. Software 62 may include any software or program configured to perform the steps or processes of the present disclosure, e.g., providing an interface for a user to provide an input to the outlet 20 and/or receive an output from the outlet 20. Further, software 62 may run and/or be included directly as part of controller 16. Software 62 may execute on a virtual machine and/or execute outside outlet 20 and/or any of the components thereof.

The processing circuitry 56 may be configured to control any of methods and/or processes described herein and/or to cause such methods, and/or processes to be performed, e.g., by outlet 20. Processor 58 corresponds to one or more processors 48 for performing outlet 20 functions described herein. The memory 60 is configured to store data and/or files such as system data and/or other information/data described herein. In some embodiments, the software 62 may include instructions that, when executed by the processor 58 and/or processing circuitry 56, causes the processor 58 and/or processing circuitry 56 to perform the processes described herein with respect to outlet 20. For example, processing circuitry 56 of the outlet 20 may include power monitoring unit 38, which may be configured to perform any of the processes, steps, or functions described herein.

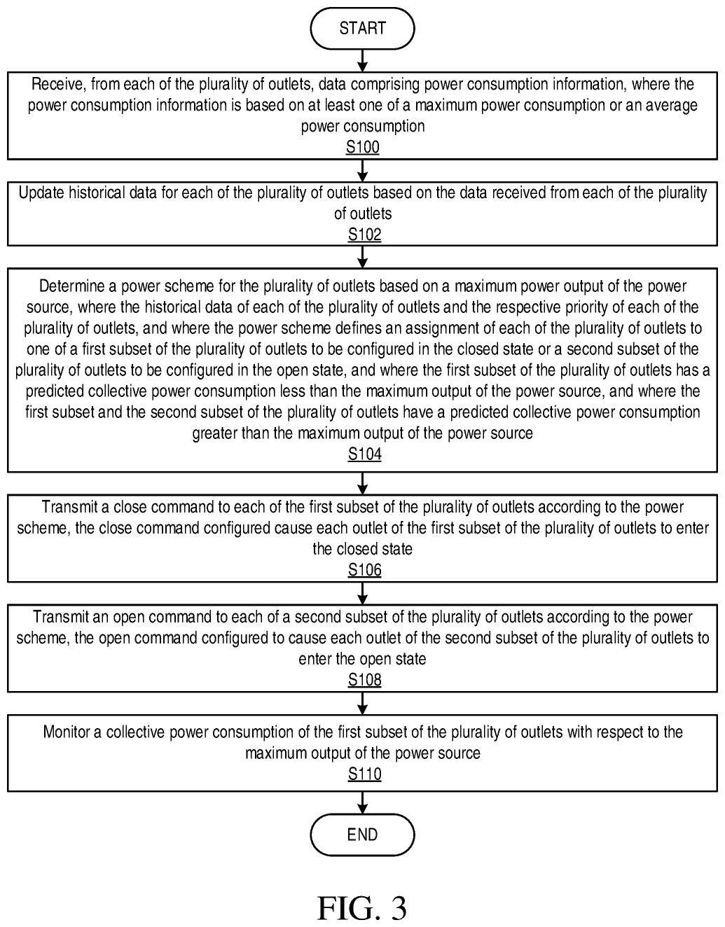

FIG. 3 is a flowchart of an example process implemented by controller 16 according to some embodiments of the present disclosure. One or more blocks described herein may be performed by one or more elements of controller 16, such as by one or more of processing circuitry 46 (including the balance unit 36) and/or processor 48 and/or communication interface 44. Controller 16 is configured to communicate with a plurality of outlets 20 and a power source 11. The plurality of outlets 20 each having a respective priority and being configured to be in one of an open state and a closed state.

Controller 16 is configured to receive (Block S100), from each of the plurality of outlets 20, data comprising power consumption information, where the power consumption information is based on at least one of a maximum power consumption or an average power consumption, as described herein. Controller 16 is configured to update (Block S102) historical data for each of the plurality of outlets 20 based on the data received from each of the plurality of outlets, as described herein. Controller 16 is configured to determine (Block S104) a power scheme for the plurality of outlets 20 based on a maximum power output of the power source 11, where the historical data of each of the plurality of outlets 20 and the respective priority of each of the plurality of outlets 20, where the power scheme defines an assignment of each of the plurality of outlets 20 to one of a first subset of the plurality of outlets 20 to be configured in the closed state or a second subset of the plurality of outlets 20 to be configured in the open state, where the first subset of the plurality of outlets 20 having a predicted collective power consumption less than the maximum output of the power source 11, where the first subset and the second subset of the plurality of outlets 20 have a predicted collective power consumption greater than the maximum output of the power source 11, as described herein.

Controller 16 is configured to transmit (Block S106) a close command to each of the first subset of the plurality of outlets 20 according to the power scheme, where the close command is configured to cause each outlet 20 of the first subset of the plurality of outlets 20 to enter the closed state, as described herein. Controller 16 is configured to transmit (Block S108) an open command to each of a second subset of the plurality of outlets 20 according to the power scheme, where the open command is configured to cause each outlet 20 of the second subset of the plurality of outlets 20 to enter the open state, as described herein. Controller 16 is configured to monitor (Block S110) a collective power consumption of the first subset of the plurality of outlets 20 with respect to the maximum output of the power source 11, as described herein.

In some embodiments, controller 16 is configured to change the assignment of an assigned outlet 20 of one of the first subset or the second subset to the other of the first subset and the second subset based on a criterion being met, where the criterion is based on at least one of: additional historical data, a change in monitored power consumption of the assigned outlet, a change in time of day, a change in day of a week, or a change in the power source.

In some embodiments, the power scheme is determined based at least on a plurality of priority parameters associated with the plurality of outlets 20, where each of the plurality of priority parameters indicates a priority of the corresponding outlet 20.

In some embodiments, the power scheme comprises a first configuration of the states of the plurality of outlets 20 and a second configuration of the states of the plurality of outlets 20, where the first configuration differs from the second configuration, and where the power scheme defines a triggering of a transition of the plurality of outlets from the first configuration to the second configuration based on a criterion being met.

Having described the general process flow of arrangements of the disclosure and having provided examples of hardware and software arrangements for implementing the processes and functions of the present disclosure, the sections below provide details and examples of arrangements for electrical outlet management. One or more controller 16 functions described below may be performed by one or more of processing circuitry 46, processor 48, balance unit 36, etc. One or more outlet 20 functions described below may be performed by one or more of processing circuitry 56, processor 58, power monitoring unit 38, etc.

An example embodiment relates to controlling individual electrical outlets 20 based on the capabilities (e.g., characteristics) of a power source 11 (e.g., a solar power system or backup generator) and the historic current consumption associated with the individual outlets 20. Controller 16 monitors one or more characteristics of individual outlets 20. For example, controller 16 monitors the output current of individual outlets 20 over time, where controller 16 may be further configured to determine an expected maximum output current for each outlet 20 based at least on one or more characteristics of the individual outlets 20. Further, the expected maximum output current may depend on, for example, the requirements of various electronic devices that draw power from the outlet 20. These requirements and/or devices may differ from one outlet 20 to another. After the expected maximum output currents are determined (e.g., as the maximum output measured during a period of time or predefined time period, such as three months), the controller 16 can turn on or off one or more outlets 20 (such as, e.g., by causing the switch 21 of an outlet 20 to close or open, respectively) when the power source 11 is providing power so that the sum of the current expected to be drawn by the outlets 20 does not exceed the maximum capability of the power source 11. For example, a backup power source 11 may have limited capability compared to a primary power source 11 such that controller 16 may be configured to turn off one or more outlets 20, based on the expected maximum output currents, in response to a switchover from the primary power source 11 to the backup power source 11. The controller 16 may be configured to determine whether a particular outlet 20 should be in an open state or closed state based on a number of factors described herein, including but not limited to the amount of available power from a power source 11, consumption of the outlet 20, a priority level assigned to the outlet 20.

At least one embodiment includes an electrical panel 13 (to which the breakers 17 and controller 16 may be connected). The outlet 20 may be, e.g., a “smart” outlet.

Next, an example of an electrical panel 13 according to various embodiments is described with reference to FIG. 1. The electrical panel 13 can include a controller 16 that communicates with the electrical outlets 20 described below (e.g., to command them to open or close internal switches 21) and a user app on a smart phone accessible via, e.g., the network 24. The controller 16 can communicate with the outlets 20 through signals over the electrical wiring and/or wirelessly. The controller 16 can be programmed with information about the power source(s) 11 for the premises. For example, the controller 16 can be programmed with information indicating that the premises in which the electrical panel 13 is installed can use grid power or backup power provided by a solar power system or on-site generator. The controller can also be programmed with information indicating the maximum permitted current output from the various power sources 11.

In at least one embodiment, functionality performed by controller 16 can be implemented in an alarm panel, smart home hub, or other device in system 10 or a premises monitoring system.

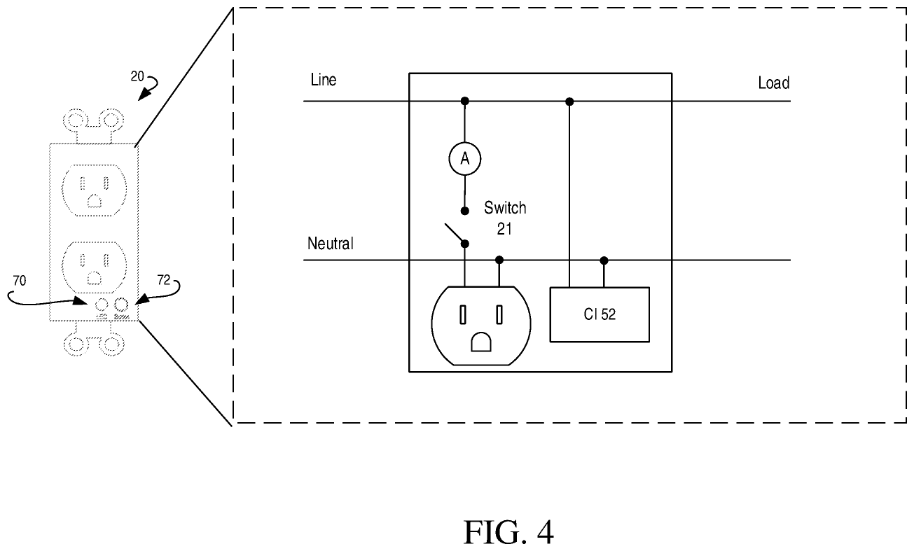

An example of a smart outlet 20 is illustrated in FIG. 4. The outlet 20 can include a light-emitting diode (“LED”) 70 that is used to indicate the outlet status. The LED can indicate, for example, that the outlet is in a learning mode (which may indicate, e.g., that the outlet 20 is measuring electrical load such as to determine typical or average load sizes that are used at the outlet 20, and/or when the system 10 is being initiated), that the outlet is operating normally, and/or that the outlet is in a mode in which it does not provide electrical power. The outlet 20 can also include a button that a user can press to control various aspects of the outlet 20. For example, a user can press the button to initiate a pairing procedure with the controller 16 in the electrical panel 13.

The right portion of FIG. 4 depicts a functional block diagram of an outlet 20. The outlet can include a current meter (e.g., as part of a power monitoring unit 38), a switch 21, and a transceiver (e.g., communication interface 54). The current meter can measure current being output by the outlet 20, e.g., to power one or more electronic device(s) connected to the outlet 20. The switch 21, when closed, allows the outlet 20 to provide electrical power via one or more mateable interfaces (e.g., one or more slits or receptacles mateable with one or more plug connectors). When the switch 21 is open, the switch 21 prevents the outlet 20 from providing electrical power.

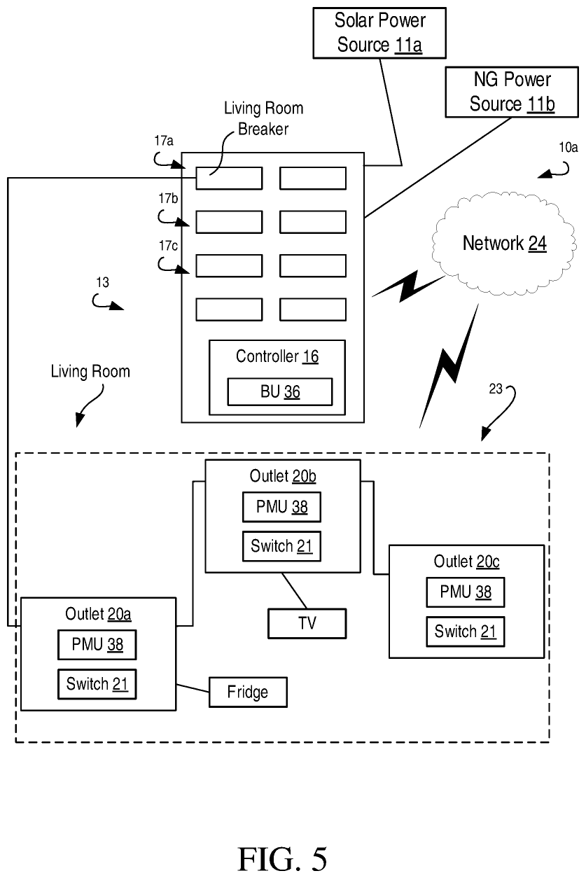

Next, operation of another example of a system 10, depicted in FIG. 5 and referred to herein as system 10a, according to various embodiments follows. First, the controller 16 and outlets 20 are installed and configured so they can communicate with each other. For example, the controller 16 and/or outlets may be manually configured to communicate with each other and/or outlets 20 may be preconfigured to automatically enroll with the controller 16. Additionally, the controller 16 is programmed with information indicating the maximum amount of current permitted to be output from the respective power source(s) 11. For example, the controller 16 can be programmed with information indicating that the maximum current output from a solar power system 11a (i.e., solar power source) connected to the electrical panel 13 is 30 amps (A). As another example, the controller 16 can be programmed with information indicating that the maximum current output from a natural gas back-up generator 11b (natural gas back-up power source) connected to the electrical panel 13 is 40 A.

Next, the controller 16 and outlets 20 enter a learning mode while the electrical panel 13 is providing grid power. During the learning mode, devices, such as appliances (e.g., refrigerators, coffee makers, etc.) televisions, lamps, etc. are plugged into respective outlets 20 and put into normal use over a period of time (e.g., a day, week, month), so that the outlets 20 can measure output current (i.e., current provided to the device(s) by respective outlets 20) and report the information (i.e., historical data) to the controller 16. The controller 16 can use the received information to determine the expected maximum amount of output current from each outlet based on this historical data.

After the controller 16 has determined the expected maximum output current for each outlet 20, the power source 11 (e.g., solar panel system and/or the generator) can provide power through the electrical panel 13, e.g., according to a power scheme, and the controller 16 can send commands to the outlets 20 to cause their respective switches 21 to open or close so that the sum of the output current for all outlets 20 does not exceed the maximum amount of current for the power source 11. Additionally, the user can assign priority levels to one or more outlets 20 so the controller 16 can attempt to avoid having the turn off high-priority outlets 20. For example, an outlet 20a providing power to a refrigerator can be assigned a higher priority level than an outlet 20b for a television, and the controller can attempt to open or close the switches 21 in the outlets 20 such that the refrigerator outlet 20a remains on while the total output current remains within limits or capabilities of the power source 11.

In at least one embodiment, the controller 16 may group the outlets 20 into one or more subsets based on common priority within the subset. For example, “high” priority outlets 20 may be grouped in one subset, and “medium” priority outlets 20 may be grouped in another subset. An outlet 20 may be reassigned from one subset to another (representing a change in the outlet's priority parameter) based on, for example, a change in the historical data, power consumption of the outlet, or available power from the power source 11. In at least one embodiment, an outlet 20 may be reassigned and/or its priority level changed based on a schedule. For example, it may be beneficial for certain outlets 20 to have a higher priority at certain times of day or days of the week, and a lower priority at other times of day or days of the week. This may allow the power scheme to adapt to variations in power needs based on, e.g., environmental conditions and/or a user's schedule. In addition, a change in power source(s) may result in a change in priority and/or grouping of outlets 20.

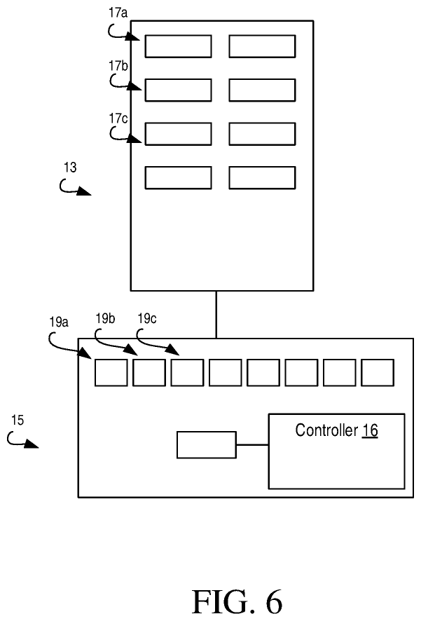

In at least one embodiment, the controller 16 is installed in an existing electrical system as a separate installation 15 from the main electrical panel 13, as shown in FIG. 6. The separate installation 15 can include the controller 16 and circuit breakers 19a-19c (collectively circuit breaker 19) that the system described herein can use and control, and which are in communication with corresponding circuit breakers 17a-17c in the electrical panel 13 (i.e., 19a to 17a, etc.). Various components in the separate installation can connect to the electrical panel 13 using any suitable means, such as but not limited to a “pig tail.” Circuit breakers 19 of the separate installation 15 may be, e.g., “smart” breakers.

The concepts described herein may be embodied as a method, data processing system, computer program product and/or computer storage media storing an executable computer program. Accordingly, the concepts described herein may take the form of an entirely hardware embodiment, an entirely software embodiment or an embodiment combining software and hardware aspect. Any process, step, action and/or functionality described herein may be performed by, and/or associated to, a corresponding module, which may be implemented in software and/or firmware and/or hardware. Furthermore, the disclosure may take the form of a computer program product on a tangible computer usable storage medium having computer program code embodied in the medium that can be executed by a computer. Any suitable tangible computer readable medium may be utilized including hard disks, CD-ROMs, electronic storage devices, optical storage devices, or magnetic storage devices.

Some embodiments are described herein with reference to flowchart illustrations and/or block diagrams of methods, systems and computer program products. Each block of the flowchart illustrations and/or block diagrams, and combinations of blocks in the flowchart illustrations and/or block diagrams, can be implemented by computer program instructions. These computer program instructions may be provided to a processor of a general purpose computer (to thereby create a special purpose computer), special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory or storage medium that can direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions and/or acts specified in the flowchart and/or block diagram block or blocks.

The functions and acts noted in the blocks may occur out of the order noted in the operational illustrations. For example, two blocks shown in succession may in fact be executed substantially concurrently or the blocks may sometimes be executed in the reverse order, depending upon the functionality and/or acts involved. Although some of the diagrams include arrows on communication paths to show a primary direction of communication, it is to be understood that communication may occur in the opposite direction to the depicted arrows.

Computer program code for carrying out operations of the concepts described herein may be written in an object-oriented programming language such as Python, Java® or C++. However, the computer program code for carrying out operations of the disclosure may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

Many different embodiments have been disclosed herein, in connection with the above description and the drawings. It would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

In addition, unless mention was made above to the contrary, the accompanying drawings are not to scale. A variety of modifications and variations are possible in light of the above teachings without departing from the scope and spirit of the present disclosure.

What is claimed is:

1. A system, comprising:
a plurality of outlets in electrical communication with each other, the plurality of outlets each having a respective priority and being configured to be in one of an open state or a closed state;
a controller in communication with the plurality of outlets and a power source, the controller comprising at least one processor and at least one computer-readable storage medium comprising a plurality of instructions that, when executed by the at least one processor, cause the at least one processor to:
receive, from each of the plurality of outlets, data comprising power consumption information, the power consumption information being based on at least one of a maximum power consumption or an average power consumption;
update historical data for each of the plurality of outlets based on the data received from each of the plurality of outlets;
determine a power scheme for the plurality of outlets based on a maximum power output of the power source, the historical data of each of the plurality of outlets and the respective priority of each of the plurality of outlets, the power scheme defining an assignment of each of the plurality of outlets to one of a first subset of the plurality of outlets to be configured in the closed state or a second subset of the plurality of outlets to be configured in the open state, the first subset of the plurality of outlets having a predicted collective power consumption less than the maximum output of the power source, the first subset and the second subset of the plurality of outlets having a predicted collective power consumption greater than the maximum output of the power source;
transmit a close command to each of the first subset of the plurality of outlets according to the power scheme, the close command configured cause each outlet of the first subset of the plurality of outlets to enter the closed state;
transmit an open command to each of a second subset of the plurality of outlets according to the power scheme, the open command configured to cause each outlet of the second subset of the plurality of outlets to enter the open state; and
monitor a collective power consumption of the first subset of the plurality of outlets with respect to the maximum output of the power source.

2. The system of claim 1, wherein the plurality of instructions is further configured to cause the at least one processor to change the assignment of an assigned outlet of one of the first subset or the second subset to the other of the first subset and the second subset based on a criterion being met; and
the criterion being based on at least one of:
additional historical data;
a change in monitored power consumption of the assigned outlet;
a change in time of day;
a change in day of a week; or
a change in the power source.

3. A system, comprising:
a controller configured to communicate with a plurality of outlets, each of the plurality of outlets being switchable between an open state and a closed state, the controller comprising at least one processor and at least one computer-readable storage medium comprising a plurality of instructions that, when executed by the at least one processor, cause the at least one processor to:
receive, from each of the plurality of outlets, data associated with power consumption of a respective outlet;
update historical data for each of the plurality of outlets based on the data received from each of the plurality of outlets;
determine a power scheme for the plurality of outlets based at least on the historical data, the power scheme being configured such that a predicted collective power consumption of the plurality of outlets is less than a maximum output of a power source; and
configure, based on the power scheme, at least one of the plurality of outlets to enter the open state and at least one other of the plurality of outlets to enter the closed state.

4. The system of claim 3, wherein the power consumption is based on at least one of a maximum power consumption or an average power consumption.

5. The system of claim 3, wherein the power scheme comprises a first subset of the plurality of outlets being in the open state and a second subset of the plurality of outlets being in the closed state.

6. The system of claim 3, wherein the power scheme is determined based at least on a plurality of priority parameters associated with the plurality of outlets, each of the plurality of priority parameters indicating a priority of the corresponding outlet.

7. The system of claim 3, wherein the power scheme comprises:
an assignment of each outlet of the plurality of outlets to one of a first subset of the plurality of outlets or a second subset of the plurality of outlets based on a respective priority parameter of each outlet;
an assignment of the first subset of the plurality of outlets to the closed state;
an assignment of the second subset of the plurality of outlets to the open state; and
the first subset of the plurality of outlets having a predicted collective power consumption less than less than a maximum output of the power source.

8. The system of claim 7, wherein the plurality of instructions is further configured to cause the at least one processor to change the assignment of at least one of the plurality of outlets from one of the first subset or the second subset to the other of the first subset or the second subset based on a change to at least one of: the historical data, a monitored power consumption, or the power source.

9. The system of claim 3, wherein:
the power scheme comprises a first configuration of the states of the plurality of outlets and a second configuration of the states of the plurality of outlets, the first configuration differing from the second configuration; and
the power scheme defines a triggering of a transition of the plurality of outlets from the first configuration to the second configuration based on a criterion being met.

10. The system of claim 9, wherein the criterion is met based on one of:
a change in time of day; or
a change in day of a week.

11. The system of claim 9, wherein the criterion is met based on a change from the power source to another power source having a different maximum output.

12. A method implemented by a system, the system comprising a controller configured to communicate with a plurality of outlets, each of the plurality of outlets being switchable between an open state and a closed state, the method comprising:
receiving, from each of the plurality of outlets, data associated with power consumption of a respective outlet;
updating historical data for each of the plurality of outlets based on the data received from each of the plurality of outlets;
determining a power scheme for the plurality of outlets based at least on the historical data, the power scheme being configured such that a predicted collective power consumption of the plurality of outlets is less than a maximum output of a power source; and
configuring, based on the power scheme, at least one of the plurality of outlets to enter the open state and at least one other of the plurality of outlets to enter the closed state.

13. The method of claim 12, wherein the power consumption is based on at least one of a maximum power consumption or an average power consumption.

14. The method of claim 12, wherein the power scheme comprises a first subset of the plurality of outlets being in the open state and a second subset of the plurality of outlets being in the closed state.

15. The method of claim 12, wherein the power scheme is determined based at least on a plurality of priority parameters associated with the plurality of outlets, each of the plurality of priority parameters indicating a priority of the corresponding outlet.

16. The method of claim 12, wherein the power scheme comprises:
an assignment of each outlet of the plurality of outlets to one of a first subset of the plurality of outlets or a second subset of the plurality of outlets based on a respective priority parameter of each outlet;
an assignment of the first subset of the plurality of outlets to the closed state;
an assignment of the second subset of the plurality of outlets to the open state; and
the first subset of the plurality of outlets having a predicted collective power consumption less than less than a maximum output of the power source.

17. The method of claim 16, further comprising changing the assignment of at least one of the plurality of outlets from one of the first subset or the second subset to the other of the first subset or the second subset based on a change to at least one of: the historical data, a monitored power consumption, or the power source.

18. The method of claim 12, wherein:
the power scheme comprises a first configuration of the states of the plurality of outlets and a second configuration of the states of the plurality of outlets, the first configuration differing from the second configuration; and
the power scheme defines a triggering of a transition of the plurality of outlets from the first configuration to the second configuration based on a criterion being met.

19. The method of claim 18, wherein the criterion is met based on one of:
a change in time of day; or
a change in day of a week.

20. The method of claim 18, wherein the criterion is met based on a change from the power source to another power source having a different maximum output.
